(19) United States
(12) Patent Application Publication
(10) Pub. No.: US 2020/0141057 A1
(43) Pub. Date: May 7, 2020

(54) CATALYTIC CONVERSION OF LIGNIN

(71) Applicant: SUNCARBON AB, TYGELSJÖ (SE)

(72) Inventors: Christian Hulteberg, BUNKEFLOSTRAND (SE); Lars Stigsson, BJÄRRED (SE)

(21) Appl. No.: 16/618,817

(22) PCT Filed: Jun. 5, 2018
(86) PCT No.: PCT/SE2018/050584

§ 371 Date: Dec. 3, 2019

Related U.S. Application Data
(60) Provisional application No. 62/515,088, filed on Jun. 5, 2017.

(51) Int. Cl. D21C 11/00; C07G 1/00; C10G 3/00; C10L 1/02

(52) U.S. Cl. CPC D21C 11/0007; D21C 11/0092; D21C 11/0021; D21C 11/0042; C07G 1/00; C10L 2270/026; C10G 3/50; C10L 1/02; C10L 2200/0469; C10L 2270/023; C10G 3/42

(57) ABSTRACT

A process for depolymerization of lignin, the process including using at least one catalyst internal to a pulp mill for performing catalytic treatment and separation of biomass components into cellulose and lignin rich material is provided.

### CROSS-REFERENCE TO RELATED APPLICATIONS

This application claims priority to PCT Application No. PCT/SE2018/050584, having a filing date of Jun. 5, 2018, which is based on U.S. Ser. No. 62/515,088, having a filing date of Jun. 5, 2017, the entire contents both of which are hereby incorporated by reference.

### FIELD OF TECHNOLOGY

The following relates to catalytic conversion of lignin originating from black liquor from the kraft process into a bio-oil product. This product is a renewable raw material for fine chemicals manufacturing and/or renewable fuel components for use in automotive or aviation sectors.

### BACKGROUND

It has long been known to the pulping industry how to depolymerise lignin in the cooking of wood to separate cellulose and hemicellulose from lignin. This is most commonly done in the kraft process where a residual liquor consisting of an aqueous solution of cooking chemicals (e.g. NaOH, sodium sulfite, sodium sulfate, sodium carbonate) comprising lignin is formed. This aqueous solution is referred to as black liquor. The objective of the kraft process cooking is to dispose of lignin and consequently the lignin in black liquor is merely used for heat production through combustion in the recovery boiler.

One aim of embodiments of the present invention is to provide unloading of the recovery boiler through an alternative outtake of lignin. Thus, enable increased production of pulp in the mill.

Lignin is a three-dimensional polymer present in all biomass. Lignin consists of a large number of interconnected C9 monomers, each monomer having an aromatic part. To be able to use lignin in other applications than for heat production, it has to be depolymerized, i.e. broken up into smaller parts. The lignin molecule is however very stable after many years of evolution, and depolymerization is thus a challenge. The size of lignin compounds in black liquor varies due to randomisation of the depolymerisation reaction, but is generally very large molecules, macromolecules, with a molecular weight up to 100 kDa. The kraft process cooking process mainly targets only one type of interconnection, the ß-O-4 bond, making depolymerization limited (G. Gellerstedt, H. Lennholm, G. Henriksson, and N.-O. Nilvebrant, Wood Chemistry. Stockholm: Kungliga Tekniska Högskolan, 2001.). This invention refers to depolymerization and deoxygenation beyond that of the kraft process.

Native lignin has naturally a high content of oxygen, 27 wt %, which is a drawback in respect to raw material for fuel components.

Another aim of embodiments of the present invention is to provide new purpose to the lignin material that is renewable raw materials for other industries by refining of the chemical structure i.e. reducing the molecular size, reducing the oxygen content and converting aromatic to aliphatic structures.

### SUMMARY

An aspect is related to a process for depolymerization of lignin, the process comprising using at least one catalyst internal to a pulp mill for performing catalytic treatment and separation of biomass components into cellulose and lignin rich material.

According to one aspect, embodiments of the present invention pertains to a process of depolymerization and partial deoxygenation of lignin integrated in a pulp-mill and in this context depolymerization is beyond the one normally considered to liberate the cellulose and hemicellulose from wood; i.e. lowering the molecular weight average of lignin from circa up to 100 kDa to the 0.8-2 kDa range. The depolymerization is catalyzed using a catalysts that is internal to the pulp mill, i.e. no foreign materials are added to enhance the depolymerization aside from materials that are normally found in the pulp mill. The internal catalysts comprise is enriched in iron compounds and/or sulfates. This is further discussed below. In addition, the catalyst may be recovered and recycled using the processes normally existing in a pulp mill. The depolymerization may or may not be supported by hydrogen or hydrogen donors.

Below specific aspects and embodiments of the present invention are disclosed and discussed.

First of all, embodiments of the present invention are very suitable to be applied in the chemistry relating to kraft processes. Therefore, according to one specific embodiment of the present invention, the process is performed on a black liquor or a black liquor retentate obtained from a kraft process.

Moreover, the catalysts may consist of liquids, possibly also some solids, found in the pulp mill, or indeed be solids that have been dissolved or activated in some way. Examples of starting materials that may be used is electrofilter ash and green liquor dregs (table 1). The catalysts may consist of the material in the example material in its entirety or parts of the material may be extracted and used. The material may also be activated before use, e.g. via calcination, reduction, sulfidation or forming sulfates.

TABLE 1
Compositions of green liquor dregs and electrofilter ash

| | | Green liquor | |
|---|---|---|---|
| ELEMENT | SAMPLE | dregs 1 | Electrofilter ash |
| TS | % | 47.7 | 99.7 |
| Si | mg/kg TS | 4030 | 1100 |
| Al | mg/kg TS | 3490 | <200 |
| Ca | mg/kg TS | 268000 | 657 |
| Fe | mg/kg TS | 4190 | <700 |
| K | mg/kg TS | 3660 | 61300 |
| Mg | mg/kg TS | 46200 | 129 |
| Mn | mg/kg TS | 18900 | 89.2 |
| Na | mg/kg TS | 29600 | 283000 |
| P | mg/kg TS | 4300 | 64.3 |
| Ti | mg/kg TS | 120 | 19.3 |
| LOI 1000° C. | % TS | 39.5 | 10.5 |
| As | mg/kg TS | 0.417 | 1.24 |
| Ba | mg/kg TS | 576 | 11.7 |
| Be | mg/kg TS | <0.5 | <0.04 |
| Cd | mg/kg TS | 21.5 | 3.22 |
| Co | mg/kg TS | 16 | 0.0265 |
| Cr | mg/kg TS | 113 | <9 |
| Cu | mg/kg TS | 273 | 0.992 |
| Hg | mg/kg TS | <0.04 | <0.04 |
| Mo | mg/kg TS | 1.03 | 2.65 |
| Nb | mg/kg TS | <5 | <5 |
| Ni | mg/kg TS | 60.8 | 0.179 |
| Pb | mg/kg TS | 34.3 | 2.55 |
| S | mg/kg TS | 18200 | 209000 |
| Sc | mg/kg TS | <1 | <0.9 |
| Sn | mg/kg TS | 0.364 | 0.0584 |
| Sr | mg/kg TS | 350 | 2.67 |
| V | mg/kg TS | 1.92 | 6.75 |
| W | mg/kg TS | <0.4 | 0.409 |
| Y | mg/kg TS | 2 | <2 |
| Zn | mg/kg TS | 3630 | 83.8 |
| Zr | mg/kg TS | 5.9 | <2 |

According to one preferred embodiment of the present invention, the process comprises using one or more of the following substances; Co, Mo and Mn, in levels higher than naturally occurring in weak black liquor.

TABLE 2
Composition of weak black liquor

| Substance | | Mixed-bas liquor | Unit |
|---|---|---|---|
| Dry matter | | 19 | % |
| Ash | | 48.48 | % |
| Carbon | C | 34.7 | % |
| Hydrogen | H | 3.8 | % |
| Nitrogen | N | 0.1 | % |
| Sodium | Na | 18 | % |
| Potassium | K | 3.25 | % |
| Zinc | Zn | 3.85 | mg/kg |
| Iron | Fe | 8.2 | mg/kg |
| Silicon | Si | 175 | mg/kg |
| Manganese | Mn | 29 | mg/kg |
| Magnesium | Mg | 58 | mg/kg |
| Vanadinium | V | 5 | mg/kg |
| Copper | Cu | 8.5 | mg/kg |
| Aluminium | Al | 9.0 | mg/kg |
| Calcium | Ca | 47 | mg/kg |
| Phosphorus | P | 79 | mg/kg |
| Barium | Ba | 2.4 | mg/kg |
| Sulfur | S | 4.55 | % |
| Chlorine | Cl | 0.1 | % |
| Carbonate | CO₃— | 5.5 | % |
| Sulphate | SO₄²— | 0.78 | % |
| Sulphide | S— | 2.31 | % |
| Thiosulfate | S₂O₃— | 1.90 | % |
| Sulphite | SO₃— | 0.49 | % |

According to yet another specific embodiment of the present invention, the process comprising using one or more of the following substances; Fe, Mg, W, Cd, As, Cu, Cr, Nb, Ni, Pd, Zn, Sr and V, in levels higher than naturally occurring in weak black liquor.

The depolymerization may be done either in an aqueous phase in the presence of alkaline compounds, such as a black liquor or a membrane-filtered black liquor and/or in solvent phase wherein the solvent may be an organic solvent, a fatty acid or a hydrocarbon. The solvent may also comprise recycled products from depolymerization. Or indeed the depolymerization may take place in a hydrocarbon phase after a substantially water and salt free lignin or lignin oil has been separated from the cooking chemicals. Aqueous and salty effluents from treatment of lignin in accordance with the present process may be partly recycled within the process to support separation of depolymerized lignin or lignin oil. All effluents are finally discharged to a pulp mill chemicals recovery cycle. The depolymerization may or may not be supported by hydrogen or hydrogen donors. Hydrogen is advantageously produced via electrolysis on site in the pulp mill wherein the oxygen stream may be used for oxygen delignification, brown stock washing or bleaching the pulp or paper product. If required, the depolymerization on lignin or lignin rich oil can be done using a two-step procedure, wherein the first depolymerization is performed as above and a second depolymerization is done under hydrogen pressure using a heterogeneous catalyst acting on a depolymerized lignin in a hydrocarbon matrix. Such depolymerization is advantageously performed in a petroleum refinery by co-processing in accordance with well established procedures for production of renewable fuels in petroleum refinery environment. The heterogeneous catalysts may consist of Ni and Mo sulfide supported on alumina, such as delta alumina, with large pores. The pores should be larger than 60 Å, larger than 80 Å and most preferable more than 100 Å. This catalyst will also reduce the metal content of the mixture.

The final product of the process of embodiments of the present invention is renewable raw materials for fine chemicals manufacturing and/or renewable fuel components for use in automotive or aviation sectors.

The above aspects and features, and also others, are further discussed below.

As mentioned above, according to one aspect of embodiments of the present invention, then hydrogenation is involved in the process. With reference to this, according to one specific embodiment of the present invention, the process comprising using hydrogen or hydrogen donors in support of depolymerization, the depolymerization performed in an aqueous phase of black liquor or black liquor retentate in the presence of alkali and/or in the presence of a solvent.

According to one specific embodiment of the present invention, the process comprises utilizing separation of a lignin-rich organic phase from an aqueous phase forming spontaneously upon hydrogen assisted heat treatment at 250-360° C. According to one embodiment, the temperature is held in the range of 300-350° C. which is the range up until today where the technique has been tested in lab scale.

When utilizing hydrogenation according to embodiments of the present invention, then the partial pressure of hydrogen may also be relevant to control. According to one specific embodiment, the process utilizes separation of a lignin-rich organic phase from an aqueous phase forming spontaneously upon hydrogen assisted heat treatment at hydrogen partial pressure of 30-100 bar. According to one embodiment, the hydrogen partial pressure is held in the range of 60-70 bar.

According to another aspect of embodiments of the present invention, the process involves heat treatment. According to one embodiment of this direction of embodiments of the present invention, side products that has a stabilizing effect on lignin, such as hemicellulose and fibers, are decomposed trough heat treatment at 170-190° C. so that the level in total of sugars composed of arabinose, galactose, glucose, xylose and mannose do not exceed 10 mg/g. The decomposition of hemicellulose and fibers, organic acids are formed which contributes to lowering of pH which in turn aids the separation of a lignin-rich organic phase from the water phase.

Moreover, and as mentioned above, the process may also involve extraction of certain substances. According to one specific embodiment of the present invention, the process comprises using green liquor dregs or electrofilter ash as source of extraction for Co, Mo, Mn, Fe, Mg, W, Cd, As, Cu, Cr, Nb, Ni, Pd, Zn, Sr or V.

Furthermore, according to one embodiment of the present invention, the catalyst is directly or indirectly recycled to and at least partly regenerated in a unit operation in the pulp mill. According to embodiment, the unit operation is the recovery boiler.

Moreover, the lignin to be treated may have originated from different sources. According to one specific embodiment of the present invention, the lignin to be treated is in black liquor with additional biomass.

According to yet another aspect of embodiments of the present invention, the process involves membrane filtration, e.g. together with heat treatment and/or subsequent hydrogenation. Therefore, according to one specific embodiment of the present invention, the lignin to be treated is concentrated using membrane filtration of black liquor.

Also, other types of processing are possible according to embodiments of the present invention. According to one specific embodiment of the present invention, the lignin in black liquor is first separated from water and cooking chemicals and then mixed into a hydrocarbon phase to enable hydrogenation before a subsequent depolymerization. According to yet another embodiment, the lignin is first depolymerized and then treated in a second step with hydrogen and a heterogeneous catalyst in a hydrocarbon phase, either at the pulp mill or on another site such as a petroleum refinery.

Moreover, and as mentioned above, also certain features of the catalyst may be important to the process according to embodiments of the present invention. According to one specific embodiment, the heterogeneous catalyst has a mean pore diameter larger than 60 Å, larger than 80 Å and most preferable larger than 100 Å.

When performing a hydrogenation in the process according to embodiments of the present invention, this may be performed in different ways. According to one embodiment, the hydrogenation reaction is performed in an ebulliated bed reactor at a total pressure of 60-100 bar, a partial pressure of hydrogen of 20-70 bar and temperatures from 330-390° C. According to yet another specific embodiment, catalyst particles in a hydrogenation reactor exit stream is filtered off and all or part is regenerated using oxygen (3-8%) and steam (20-30%) in nitrogen at a temperature in a range of 400-800° C. and re-sulfidated before it is returned to the reactor.

Furthermore, sulfidation of the heterogeneous catalyst may be performed using off-gases from a pulp mill. Further, according to yet another embodiment, the reaction exotherm is handled by either cooling the ebulliated bed reactor by indirect steam generation and/or by cooling part of the resulting product and recirculating it to the inlet.

Furthermore, the process according to embodiments of the present invention also has other aspects. As an example, the process according to embodiments of the present invention may reduce the sodium content of process material. In line with this, according to one specific embodiment of the present invention, wherein the catalytic treatment, separation or purification operations reduces the Na content to below 10 ppm.

Moreover, the process according to embodiments of the present invention may also include co-processing or subsequent processing. According to one specific embodiment of the present invention, a produced final product is used as a raw material for fine chemicals production or as a fuel component in transportation fuel. Furthermore, according to yet another specific embodiment, hydrogen used is produced via electrolysis and the co-product oxygen is used in bleaching the pulp or paper.

### BRIEF DESCRIPTION

Some of the embodiments will be described in detail, with reference to the following figures, wherein like designations denote like members, wherein:

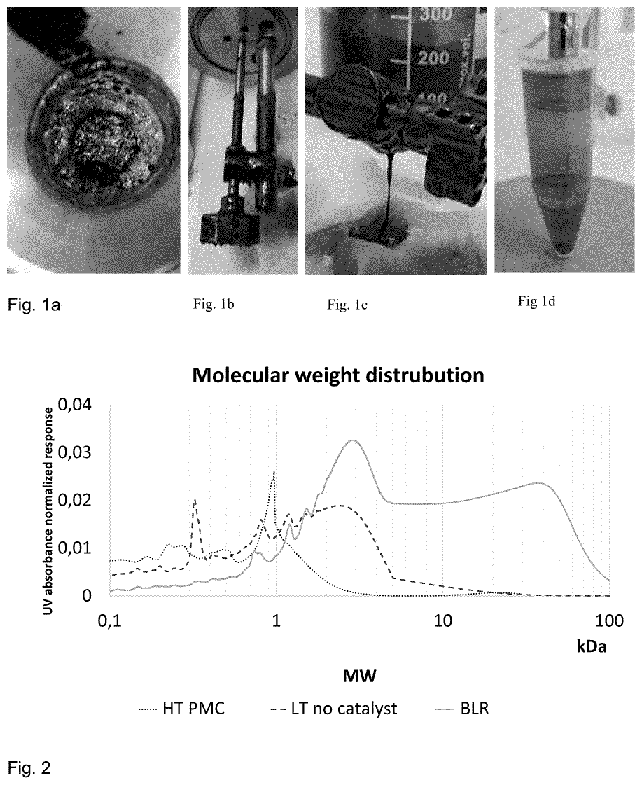

FIG. 1a shows a lignin-rich organic phase at room temperature, in accordance with embodiments of the present invention;

FIG. 1b shows the lignin-rich organic phase at room temperature, in accordance with embodiments of the present invention;

FIG. 1c shows the lignin-rich organic phase at room temperature, in accordance with embodiments of the present invention;

FIG. 1d shows a see-through aquatic phase with a submerged pH probe, in accordance with embodiments of the present invention;

FIG. 2 shows an analysis through size exclusion chromatography, in accordance with embodiments of the present invention;

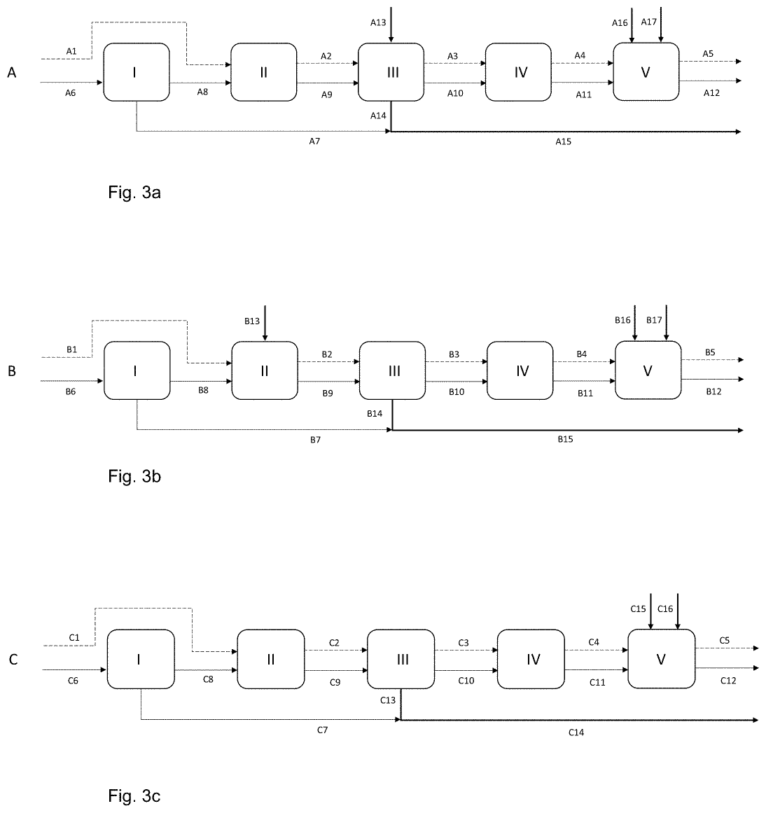

FIG. 3a shows a first process in accordance with embodiments of the present invention;

FIG. 3b shows a second process in accordance with embodiments of the present invention; and

FIG. 3c shows a third process in accordance with embodiments of the present invention.

### DETAILED DESCRIPTION

### Example 1

In this example, a lignin-rich organic phase is separated from an aquatic phase starting from black liquor or membrane filtered black liquor.

It was surprisingly discovered that a lignin-rich organic phase separated from an aquatic phase upon heat treatment of black liquor or membrane filtered black liquor at 300-350° C. and in a hydrogen atmosphere in batch autoclave experiments. The starting material, black liquor or membrane filtered black liquor is completely opaque before treatment. During treatment, the starting material was separated into one see-through aquatic phase and one opaque lignin-rich organic phase dark in color with higher density than the aquatic phase (FIGS. 1a-d). FIGS. 1a-c shows the lignin-rich organic phase at room temperature and FIG. 1d shows the see-through aquatic phase with a submerged pH-probe. The lignin-rich organic phase is liquid at temperatures above 130° C. and partly solidified at room temperature.

### Example 2

In this example, the hydrogen consumption in heat treatment of black liquor or membrane filtered black liquor at 300-350° C. under hydrogen atmosphere is increased by the addition of Co and/or Mo.

In batch autoclave experiments, the hydrogen consumption without any addition of catalyst was 0.39 mol H₂ per mol of lignin monomer. The addition of Co in relation to lignin monomer 1:700 on a molar basis increased the hydrogen consumption to 0.58 mol H₂ per mol of lignin monomer which correspond to an increase of 49%. The addition of Mo in the same relation, 1:700 to lignin monomers on a molar basis, showed no increase in the total consumption, but an increase of the consumption rate. The combination of the two catalysts in relation 1:1:700 (Co:Mo:lignin monomers) on a molar basis gave a synergetic effect and resulted in a total consumption of 0.78 mol H₂ per mol of lignin monomer which correspond to an increase by 100% compared to the experiment without any catalyst added. These conditions were tested at 350° C. which showed yet higher consumption, 1.18 mol H₂ per mol of lignin monomer.

TABLE 3
Approximate hydrogen consumption of
varying catalyst and temperature

| | | Approx. H₂-consumtion |
|---|---|---|
| | Temperature | (mol H₂/mol lignin |
| Catalyst added | (° C.) | monomer) |
| No catalyst | 300 | 0.39 |
| Co | 300 | 0.58 |
| Mo | 300 | 0.39 |
| Co, Mo | 300 | 0.78 |
| Co, Mo | 350 | 1.18 |

### Example 3

In this example, polysaccharides in black liquor or membrane filtered black liquor are decomposed during heat treatment above 170° C. In one specific embodiment of the process, lignin in black liquor or membrane filtered black liquor is separated through formation of a liquid lignin phase through CO₂-acidulation. The decomposition of polysaccharides is vital to this specific embodiment.

Experiments of separation through CO₂-acidulation was performed in batch autoclave on two different materials of membrane filtered black liquor, referred to as BLR #1 and BLR #2. None of the materials were able to form a liquid lignin phase unless it had first undergone heat treatment. The same phenomenon has been observed for black liquor. Analyses showed that the heat treatment lowered the total amount of polysaccharides of BLR #1 and BLR #2 from 34.7 mg/g to 9.9 mg/g and 16.6 to 8.4 respectively.

TABLE 4
Content of saccharides in membrane filtered black liquor, BLR.

| | | | | | | | Sepa- |
|---|---|---|---|---|---|---|---|
| | Ara | | | | | | ration |
| | (mg/ | Gal | Glu | Xyl | Man | Sum | suc- |
| Material | g) | (mg/g) | (mg/g) | (mg/g) | (mg/g) | (mg/g) | cessful |
| BLR #1 | 4.83 | 4.90 | 2.74 | 22.26 | — | 34.73 | No |
| Heat | 1.54 | 2.31 | 1.38 | 4.63 | — | 9.86 | Yes |
| treated | | | | | | | |
| BLR #1 | | | | | | | |
| BLR #2 | 3.57 | 3.76 | 0.72 | 8.53 | — | 16.58 | No |
| Heat | 1.67 | 2.51 | 0.45 | 3.37 | 0.36 | 8.36 | Yes |
| treated | | | | | | | |
| BLR #2 | | | | | | | |

### Example 4

In this example, a lignin-rich organic phase originating from any of the embodiments regarding separation of lignin within the process is converted to a bio-oil through hydrogenation over a heterogeneous catalyst. The bio-oil is free of water and has properties suitable for fuel production.

Catalytic hydrogenation experiments have been performed in a batch autoclave. A mixture of lignin material and hydrocarbon carrier was either heated together with the catalyst from room temperature or fed to a preheated catalyst in hydrocarbon carrier. The lignin feed material was either separated trough high temperature treatment in the presence of hydrogen explained in Example 1 or separated through CO₂-acidulation described in Example 3. The product of every feed material was a color-less hydrocarbon liquid comprising both the carrier hydrocarbon and a bio-oil originating from the lignin material. By a gravimetrical method the yield of lignin material to this bio-oil was determined, ranging from 61 to 99%. A majority of the product oil was within the gasoline or diesel boiling range. The remainder of the material was heavier hydrocarbons that could be refined into gasoline and diesel. Bi-products of the reaction are short carbons in gas phase and coke. It was found that the coke formation was much lower in the preheated setup compared to the system heated from room temperature. The catalytic conversion of aromatic to aliphatic structures was efficient and phenolic hydroxyls were very low making the quality of the product suitable for fuel production.

TABLE 5
Characteristics of the product after hydrogenation

| | | | Aliphatic-H to | |
|---|---|---|---|---|
| Lignin separation | Yield | Coke | Aromatic-H | Phenolic-OH |
| method described in | (%) | (%) | (H:H) | (mmol/g) |
| Example 1 | 68 | 27 | 41:1 | 0.003 |
| Example 3 | 58 | 10 | 136:1 | 0.019 |
| Example 3 | 80 | <1 | 99:1 | 0.011 |
| Example 3 | 85 | 3 | 99:1 | 0.010 |
| Example 3 | 61 | <1 | 99:1 | 0.014 |
| Example 3 | 88 | 4 | 131:1 | 0.010 |
| Example 3 | 99 | 3 | 61:1 | — |

### Example 5

In this example, partial deoxygenation is performed of lignin in membrane filtered black liquor through heat treatment alone or heat treatment in hydrogen atmosphere.

The chemical composition of lignin in membrane filtered black liquor is altered during heat treatment with or without hydrogen atmosphere. Analyses of carbon, hydrogen, nitrogen, sulfur and oxygen was performed on 5 samples that had undergone different treatment. Mild heat treatment reduced the oxygen content was reduced from 27 to 22% (w/w), while severe heat treatment in combination with hydrogen atmosphere reduced the oxygen content from 27 to 12% (w/w).

TABLE 6
Chemical composition of lignin in membrane filtered black
liquor after various treatments (% w/w on dry basis)

| Treatment | C | H | N | S | O |
|---|---|---|---|---|---|
| No treatment | 63.5 | 5.80 | 0.16 | 1.58 | 26.6 |
| Mild heat treatment | 67.9 | 5.55 | 0.20 | 1.01 | 22.1 |
| Mild heat treatment with hydrogen | 67.5 | 5.57 | 0.19 | 1.06 | 22.3 |
| Severe heat treatment with hydrogen | 78.3 | 5.55 | 0.40 | 0.72 | 12.0 |
| Severe heat treatment with hydrogen | 76.9 | 5.77 | 0.33 | 0.59 | 12.2 |
| and catalyst internal to a pulp | | | | | |
| mill | | | | | |

### Example 6

In this example, the average molecular weight of lignin in membrane filtered black liquor is reduced through heat treatment alone or catalytic heat treatment in hydrogen atmosphere with catalyst internal to a pulp mill.

The molecular weight distribution of lignin in membrane filtered black liquor is ranging from 1 to 100 kDa with a substantial proportion above 10 kDa. This is shown by “BLR” in FIG. 2 (analysis through size exclusion chromatography). After low temperature heat treatment, no catalyst added, the majority of the molecular weight distribution is below 10 kDa with an average around 2-3 kDa. This is shown by “LT no catalyst” in FIG. 2. After treatment at high temperature with hydrogen and addition of catalysts internal to a pulp mill, the molecular weight average is around 1 kDa, and the majority of the molecules is below 3 kDa, shown by “HT PMC” in FIG. 2.

### Example 7

In this example, the drawings of the process are described. In FIGS. 3a-c there are shown block diagrams or flow charts of different embodiments according to the present invention. The different routes according to these embodiments are explained below by viewing the tables.

According to FIG. 3a, process A can be performed either with black liquor (dotted line, A1-A5) or on membrane filtered black liquor (solid line A6-A12). According to this design, heat treatment (II) is performed at 170-240° C. followed by separation through CO₂-acidulation (III).

According to FIG. 3b process B can be performed either with black liquor (dotted line, B1-B5) or on membrane filtered black liquor (solid line B6-B12). According to this design, heat treatment (II) is performed at 300-350° C. in combination with catalysts internal to a pulp mill and hydrogen followed by spontaneous separation (III).

According to FIG. 3c, process C can be performed either with black liquor (dotted line, C1-C5) or on membrane filtered black liquor (solid line C6-C12). According to this design, heat treatment (II) is performed at 300-350° C. without pulp mill catalyst or hydrogen or followed by spontaneous separation (III).

Purification (IV) and hydrogenation (V) is alike for all designs A-C.

| | Explanation |
|---|---|
| Stream | |
| A1 | black liquor |
| A2 | heat treated black liquor |
| A3 | lignin-rich organic phase separated trough CO2-acidulation |
| A4 | lignin-rich organic phase after purification |
| A5 | product after hydrogenation |
| A6 | black liquor |
| A7 | permeate of membrane filtered black liquor, water, cooking |
| | chemicals and small lignin fragments |
| A8 | membrane filtered black liquor |
| A9 | heat treated membrane filtered black liquor |
| A10 | lignin-rich organic phase separated trough CO₂-acidulation |
| A11 | lignin-rich organic phase after purification |
| A12 | product after hydrogenation |
| A13 | CO₂ |
| A14 | aquatic phase from CO₂ separation |
| A15 | effluents returned to pulp mill chemical recovery cycle |
| A16 | H₂ |
| A17 | hydrocarbon carrier |
| Unit | |
| operation | |
| AI | membrane filtration |
| AII | heat treatment 170-240° C. |
| AIII | separation with CO₂ |
| AIV | Purification |
| AV | Hydrogenation |
| Stream | |
| B1 | black liquor |
| B2 | heat treated black liquor with hydrogen |
| B3 | lignin-rich organic phase |
| B4 | lignin-rich organic phase after purification |
| B5 | product after hydrogenation |
| B6 | black liquor |
| B7 | permeate of membrane filtered black liquor, water, cooking |
| | chemicals and small lignin fragments |
| B8 | membrane filtered black liquor |
| B9 | membrane filtered black liquor heat treated with hydrogen |
| B10 | lignin-rich organic phase |
| B11 | lignin-rich organic phase after purification |
| B12 | product after hydrogenation |
| B13 | H₂ |
| B14 | aquatic phase from spontaneous phase separation |
| B15 | Effluents returned to pulp mill chemical recovery cycle |
| B16 | H₂ |
| B17 | hydrocarbon carrier |
| Unit | |
| operation | |
| BI | membrane filtration |
| BII | heat treatment 300-350° C. |
| BIII | spontaneous phase separation |
| BIV | Purification |
| BV | Hydrogenation |
| Stream | |
| C1 | black liquor |
| C2 | heat treated black liquor |
| C3 | lignin-rich organic phase |
| C4 | lignin-rich organic phase after purification |
| C5 | product after hydrogenation |
| C6 | black liquor |
| C7 | permeate of membrane filtered black liquor, water, cooking |
| | chemicals and small lignin fragments |
| C8 | membrane filtered black liquor |
| C9 | heat treated membrane filtered black liquor |
| C10 | lignin-rich organic phase |
| C11 | lignin-rich organic phase after purification |
| C12 | product after hydrogenation |
| C13 | aquatic phase from spontaneous phase separation |
| C14 | effluents returned to pulp mill chemical recovery cycle |
| C15 | H₂ |
| C16 | hydrocarbon carrier |
| Unit | |
| operation | |
| CI | membrane filtration |
| CII | heat treatment 300-350° C. |
| CIII | spontaneous phase separation |
| CIV | Purification |
| CV | Hydrogenation |

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1-19. (canceled)

20. A process for depolymerization of lignin, the process comprising:
utilizing at least one catalyst internal to a pulp mill, the at least one catalyst occurring naturally in the pulp mill, for performing catalytic treatment and separation of biomass components into cellulose and lignin rich material;
utilizing green liquor dregs or electrofilter ash as source of extraction for one or more of the catalyst components Co, Mo, Mn, Fe, Mg, W, Cd, As, Cu, Cr, Nb, Ni, Pd, Zn, Sr or V;
wherein the process is performed on a black liquor or black liquor retentate obtained from a kraft process;
wherein the process comprises utilizing one or more of the following substances; Fe, Mg, W, Cd, As, Cu, Cr, Nb, Ni, Pd, Zn, Sr and V, in levels higher than naturally occurring in weak black liquor.

21. The process according to claim 20, further comprising utilizing one or more of the following substances; Co, Mo and Mn, in levels higher than naturally occurring in weak black liquor.

22. The process according to claim 20, further comprising utilizing hydrogen or hydrogen donors in support of depolymerization, the depolymerization performed in an aqueous phase of black liquor or black liquor retentate in a presence of alkali and/or in a presence of a solvent.

23. The process according to claim 20, the process utilizing separation of a lignin-rich organic phase from an aqueous phase forming spontaneously upon hydrogen assisted heat treatment at 250-360° C.

24. The process according to claim 20, the process utilizing separation of a lignin-rich organic phase from an aqueous phase, the separation forming spontaneously upon hydrogen assisted heat treatment at 300-350° C.

25. The process according to claim 20, wherein side products that have a stabilizing effect on lignin are decomposed trough heat treatment at 170-190° C. so that a level in total of sugars composed of arabinose, galactose, glucose, xylose and mannose does not exceed 10 mg/g.

26. The process according to claim 20, wherein the catalyst is directly or indirectly recycled to and at least partly regenerated in a unit operation in the pulp mill.

27. The process according to claim 26, wherein the unit operation is a recovery boiler.

28. The process according to claim 20, wherein the lignin to be treated is in black liquor with additional biomass.

29. The process according to claim 20, wherein the lignin to be treated is concentrated using membrane filtration of black liquor.

30. The process according to claim 20, wherein the lignin in black liquor is first separated from water and cooking chemicals and then mixed into a hydrocarbon phase before depolymerization.

31. The process according to claim 20, wherein the lignin is first depolymerized and then treated in a second step with hydrogen and a heterogeneous catalyst in a hydrocarbon phase, either at the pulp mill or on another site, the other site being a petroleum refinery.

32. The process according to claim 31, wherein the heterogeneous catalyst has a mean pore diameter larger than 60 Å.

33. The process according to claim 22, wherein hydrogen is produced via electrolysis and the co-product oxygen is used in bleaching the pulp or paper.

34. The process according to claim 20, wherein the catalytic treatment, separation or purification operations reduces the Na content to below 10 ppm.

35. The process according to claim 20, wherein a produced final product is used as a raw material for fine chemicals production or as a fuel component in transportation fuel.
